(19) United States
(12) Patent Application Publication
(10) Pub. No.: US 2012/0266731 A1
(43) Pub. Date: Oct. 25, 2012

(54) FOOD PRODUCT SLICER WITH REMOVABLE SLIDE ROD

(76) Inventors: Guangshan Zhu, Richmond Hill, GA (US); Howard A. Hartley, Brookville, OH (US)

(21) Appl. No.: 13/397,333

(22) Filed: Feb. 15, 2012

Related U.S. Application Data
(60) Provisional application No. 61/476,935, filed on Apr. 19, 2011.

(51) Int. Cl. B26D 7/06; B26D 1/12

(52) U.S. Cl. 83/713

(57) ABSTRACT

A food product slicer includes a base, a knife mounted for rotation relative to the base and a carriage mounted to the base for reciprocal movement back and forth past a cutting edge of the knife. The carriage includes a food product tray and an associated slide rod with a food product pusher mounted on the slide rod. The slide rod is removably attached to the tray to facilitate simple removal of the product pusher.

### CROSS-REFERENCES

This application claims the benefit of provisional application Ser. No. 61/476,935, filed on Apr. 19, 2011, the entirety of which is incorporated herein by reference.

### TECHNICAL FIELD

The present application relates generally to food product slicers of the type commonly used to slice bulk food products and, more particularly, to a removable slide rod arrangement for a food product slicer.

### BACKGROUND

Typical reciprocating food slicers have a rotatable, circular or disc-like slicing blade or knife, an adjustable gauge plate for determining the thickness of the slice and a carriage and associated food product tray movably mounted to the slicer base or housing so that the tray supports the food as it is moved back and forth past the cutting edge of the knife during slicing. Gravity feed slicers commonly utilize a food product pusher that is mounted to a slide rod on the tray. The food product pusher is slidably and rotatably mounted to the slide rod and is positioned to engage the food product and urge the food product toward the slicer knife side of the tray during slicing.

It would be desirable to provide a slide rod arrangement that is removable from the tray to facilitate cleaning of the slide rod and food grip. It would also be desirable to provide such an arrangement in which tools are not needed to remove the slide rod.

### SUMMARY

In one aspect, a food product slicer includes a base, a knife mounted for rotation relative to the base and a carriage mounted to the base for reciprocal movement back and forth past a cutting edge of the knife. The carriage includes a food product tray and an associated slide rod with a food product pusher mounted on the slide rod. The slide rod is removably attached to the tray to facilitate simple removal of the product pusher.

In another aspect, a food product slicer includes a base, a knife mounted for rotation relative to the base and a carriage mounted to the base for reciprocal movement back and forth past a cutting edge of the knife. The carriage includes a food product tray, a slide rod and a product pusher mounted to the slide rod. The slide rod is removably retained to the carriage via a moveable biased member.

In a further aspect, a food product slicer includes a base, a knife mounted for rotation relative to the base and a carriage mounted to the base for reciprocal movement back and forth past a cutting edge of the knife. The carriage includes a food product tray, a slide rod including a threaded portion, and a product pusher mounted to the slide rod. The slide rod is retained by securing the threaded portion into a threaded opening to enable the slide rod to be removed without the use of tools.

### BRIEF DESCRIPTION OF DRAWINGS

FIG. 1 is side elevation of a food product slicer;

FIG. 2 is a perspective of one embodiment of a slide rod arrangement;

FIG. 3 is an enlarged perspective view of part of the arrangement of FIG. 2;

FIG. 4 is an enlarged perspective view of an end portion of the slide rod of the arrangement of FIG. 3;

FIG. 5 is a perspective view of another slide rod arrangement;

FIG. 6 is a perspective view of the slide rod for the arrangement of FIG. 5;

FIG. 7 is a perspective view of another slide rod arrangement;

FIG. 8 is an end view of the bracket of the arrangement of FIG. 7;

FIG. 9 is a perspective view of the slide rod of the arrangement of FIG. 7;

FIG. 10 is an enlarged perspective view of the handle end of the arrangement of FIG. 7;

FIG. 11 is a perspective view of the arrangement of FIG. 7 in connection with a slicer tray and food product pusher;

FIG. 12 is a perspective view of another slide rod arrangement;

FIG. 13 is a perspective view of the slide rod of the arrangement of FIG. 12; and

FIG. 14 is a perspective view of the slide rod arrangement of FIG. 12 with a product pusher mounted on the slide rod.

### DESCRIPTION

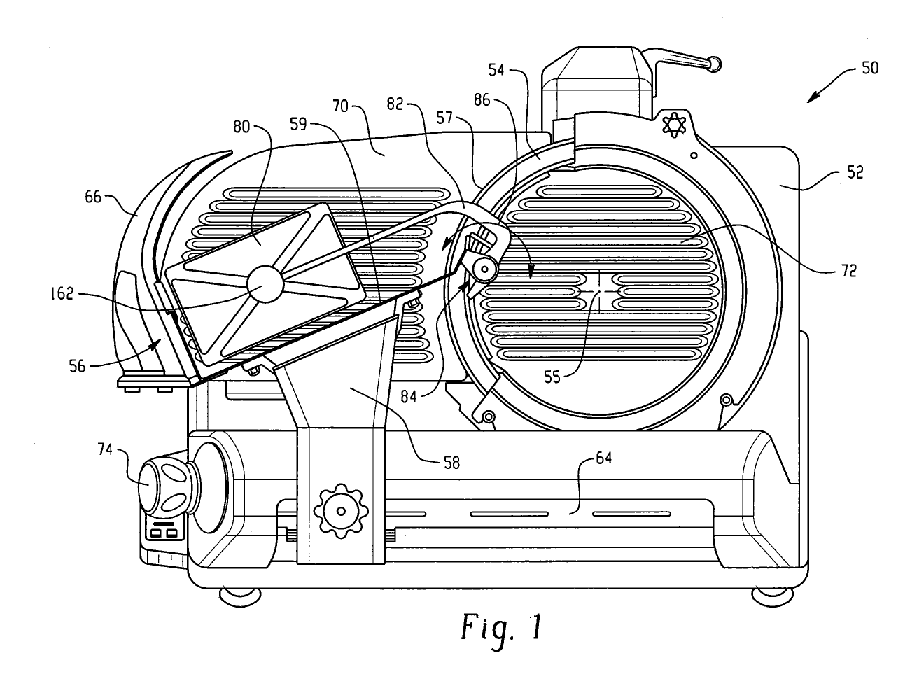

Referring to FIG. 1, a food product slicer 50 includes a housing or base 52 and a circular, motor-driven slicing knife 54 that is mounted to the housing for rotation about an axis 55. The left side of FIG. 1 is generally referred to as the front side of the slicer (which is where an operator stands for slicing), the right side of FIG. 1 is generally referred to as the rear side of the slicer and FIG. 1 depicts a right side elevation view of the slicer. A food product can be supported on a manually operable food carriage 56 which moves the food product to be sliced past the cutting edge 57 of the rotating slicing knife 54. The food carriage 56 reciprocates from left to right relative to FIG. 1, along a linear path so that the lower end of the bulk food product slides along the surface of the gauge plate 70, is cut by the knife 54 and then slides along a knife cover plate 72. Food carriage 56 includes a tray 59 mounted on a tray arm 58 that orients the food carriage tray at the appropriate angle (typically perpendicular) to the cutting edge plane. The cutting edge plane and gauge plate plane are offset from vertical and the bottom surface of the tray is therefore angled relative to horizontal (e.g., into the page and downward in the view of FIG. 1) so that food product will tend to slide down along the bottom surface toward the gauge plate and knife during slicing operations. A food product pusher 80 is mounted via an arm 82 to a slide rod 84 that, in the illustrated embodiment, is located at the rear side of the tray 59. The mount of the arm 82 to the slide rod is a rotatable mount to enable rotation of the pusher about the axis of the slide rod per 86, and is also a slidable mount the enables the arm 82 and pusher 80 to move along the length of the slide rod.

The food carriage reciprocates in a slot 64 at a lower portion of the housing 52 and a handle 66 is mounted to the food carriage 56. The handle is graspable by a user and can be used to manually move the food carriage. The carriage may also be automatically driven (e.g., as by a motor drive or other prime mover within the housing and linked to the carriage). A handle 74 for adjusting the gauge plate to control slice thickness is also provided.

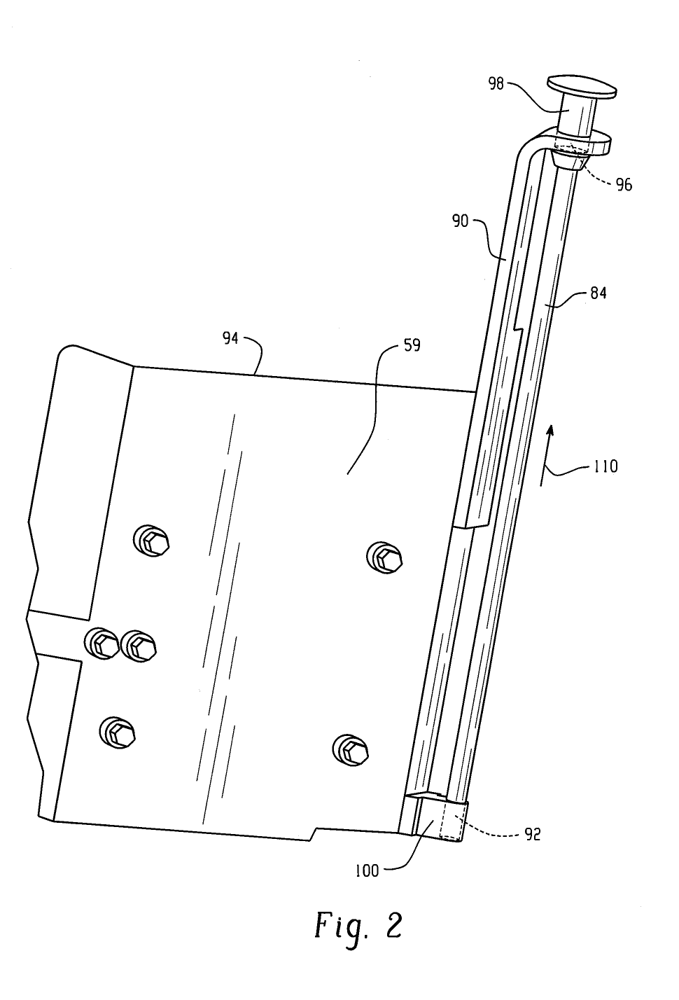

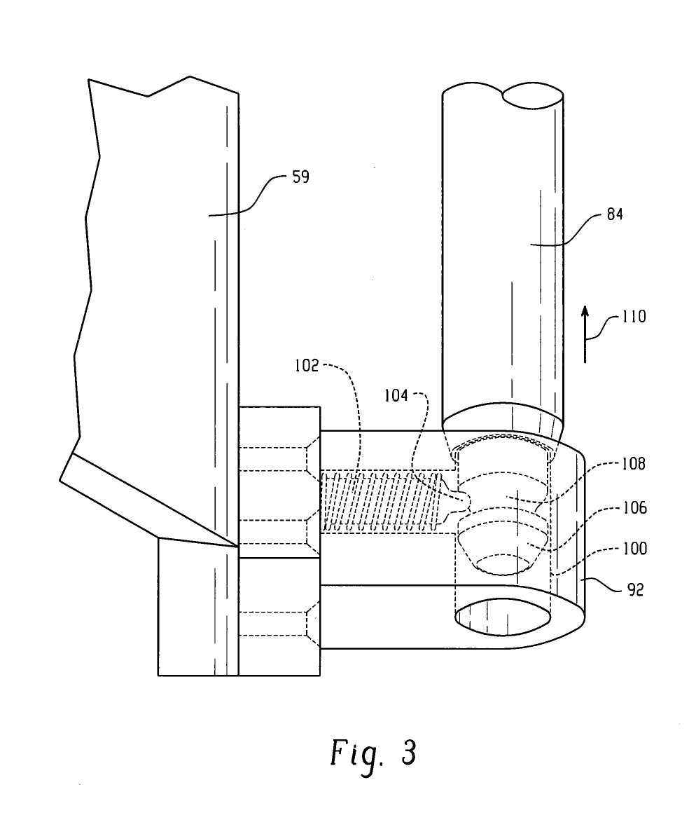

Referring to FIGS. 2-4, in one embodiment the slide rod 84 is removably mounted to the tray 59 using a bracket 90 and a bracket 92, each of which may be secured to the tray via any suitable means such as fasteners (e.g., screws or bolts) or welding. Bracket 90 extends outward beyond the higher side edge 94 of the tray, which in the context of arrangement of FIG. 1 would be the right side edge of the tray. An unthreaded opening 96 is provided in the bracket through which a handle portion 98 of the slide rod can freely slide. The bracket 92 includes an unthreaded opening 100 that slidably receives the opposite end of the slide rod 84. As best seen in FIG. 3, a spring-biased pin 102 is located internal of the bracket and includes an end portion 104 that is biased toward and into the opening 100. The inserted end 106 of the slide rod 84 includes a groove 108 into which the end portion 104 of the pin seats to hold the slide rod in place.

To remove the slide rod, the user simply grasps the handle 98 and pulls the slide rod in the direction of arrow 110 with a sufficient amount of force such that interaction between the end portion 104 of the pin and the end portion 106 of the slide rod urges the pin 102 away from the opening, allowing the slide rod to pull out of the opening. The food grip (not shown) can then slide off of the free end of the slide rod, allowing the food grip to be taken to a sink or dishwasher for cleaning. The slide rod itself can also be removed from the tray entirely (e.g., by pulling the end 106 of slide rod entirely through the opening 96 of the bracket 90). An opposite movement of the slide rod end 106 into the opening 100 with sufficient force to temporarily move the pin 102 enables the slide rod to be re-installed on the tray for use.

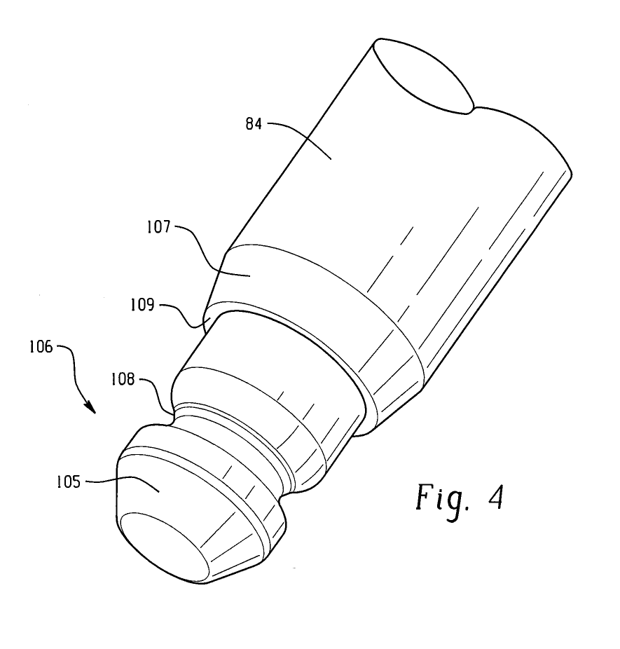

As shown in FIG. 4, the slide rod end 106 may also include tapered surface portions 105 and 107 to facilitate insertion of the end of the rod into the bracket opening 100 and an annular stop surface 109, defined by a step in the diameter of the rod, for engaging with a portion of the bracket 92. When the stop surface reaches engages with the bracket to prevent further insertion of the rod, the groove 108 will be aligned with the pin end 104. The base of the handle 98 may also include a taper to facilitate insertion in opening 96 of bracket 90.

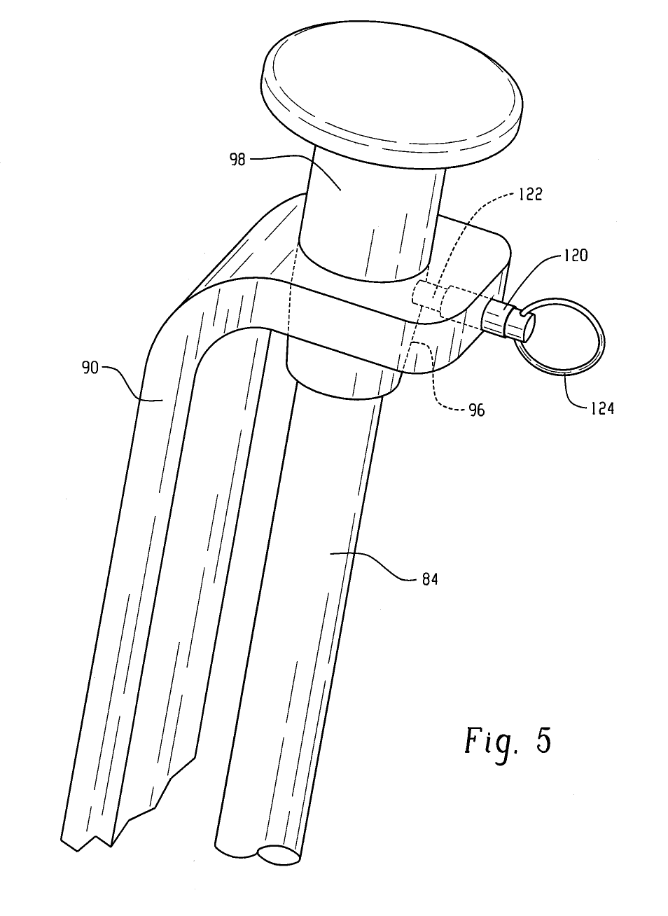

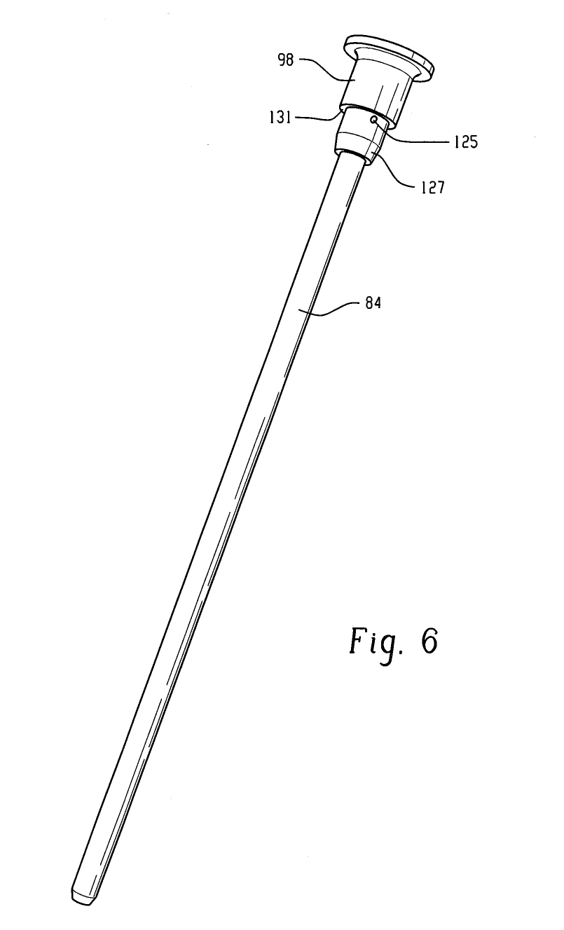

Referring to FIGS. 5 and 6, in an alternative embodiment, a spring-biased pin 120 is located on the bracket 90 and arranged to have its inward end 122 urged toward and extend into the opening 96 to engage the base of the slide rod handle 98 directly to hold the slide rod in place. The base of the slide rod handle may include a groove or hole 125 to received the end 122 of the pin 120. The external end of the pin 120 includes a ring 124 or other grip that can be used to pull the pin away from the handle base to permit removal of the handle. Alternatively, similar to the embodiment of FIGS. 2 and 3, the spring-biased pin 120 may be self-contained within the bracket and the slide rod removed by simply overcoming the bias of the pin 120. In the embodiment of FIGS. 5-6, the lower bracket 92 (not shown) would simply include an unthreaded opening that freely receives the opposite end of the slide rod 84. The base of the handle 98 includes a tapered surface 127 and the opposite end of the slide rod 84 includes a tapered surface as well, again to facilitate insertion in the respective bracket opening. A stop surface 131 is provided on the handle to engage with a portion of the bracket 90 defining the limit of movement of the handle through the bracket, and assuring alignment of the hole 125 with the pin 122. A keyway feature may be added to assure proper circumferential position of the hole 125 relative to the pin 122.

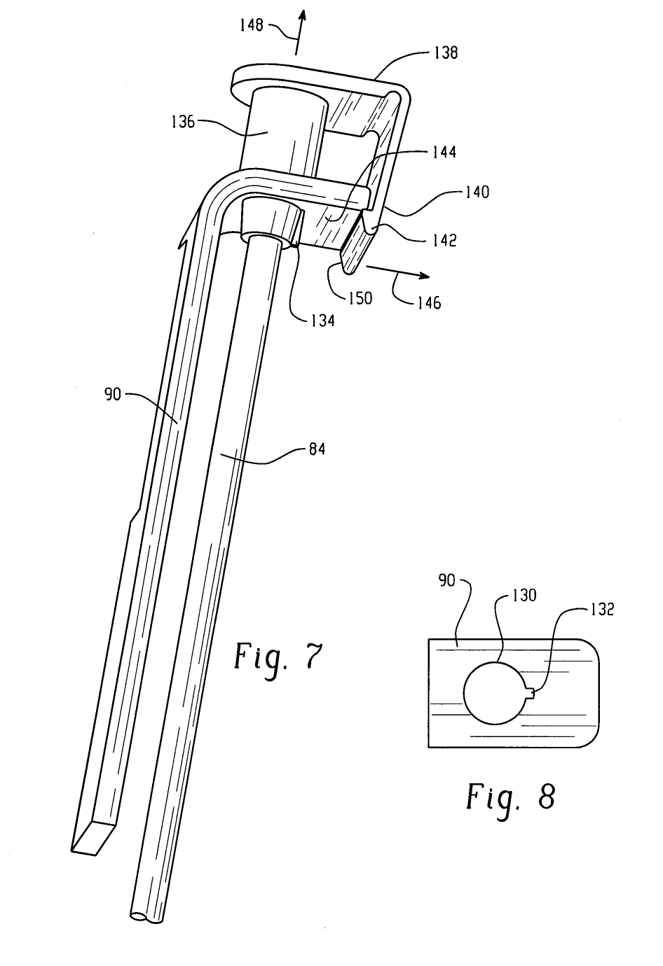

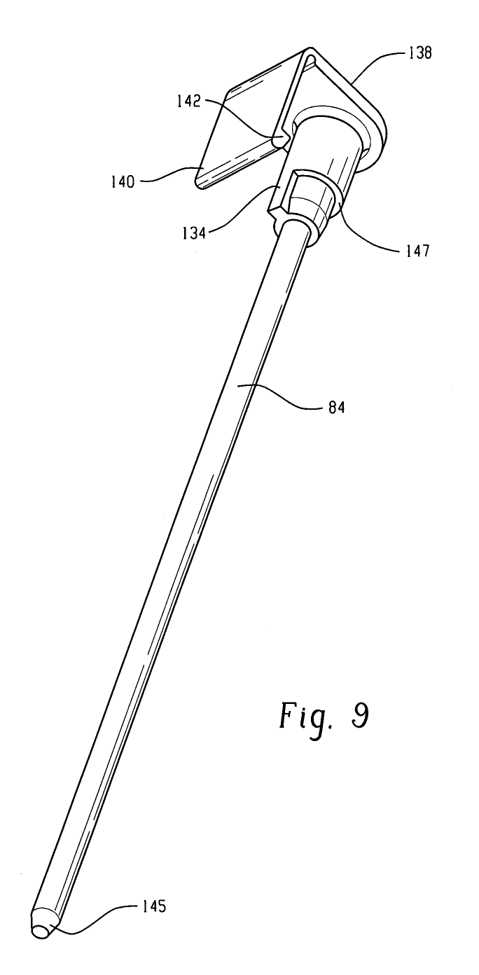

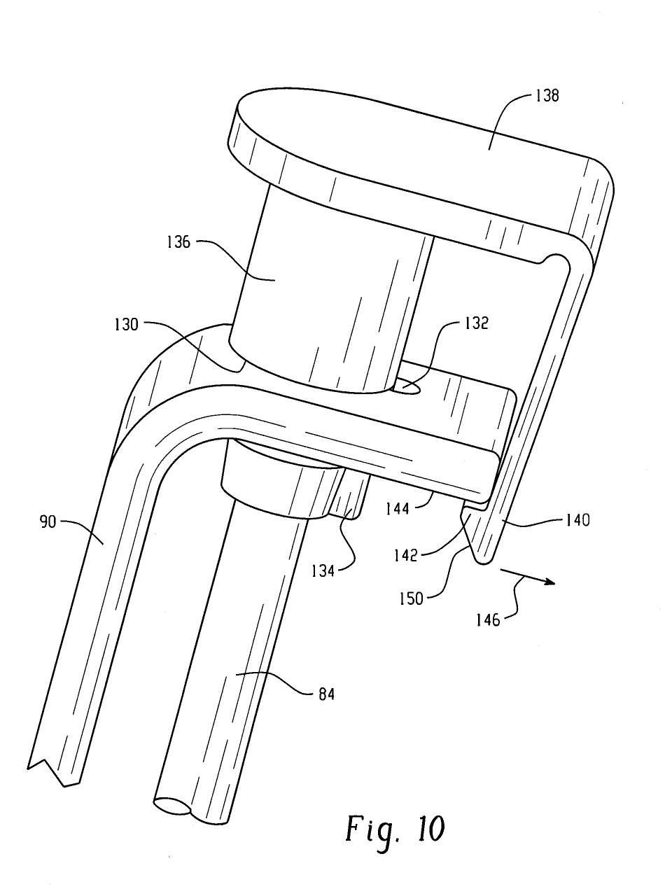

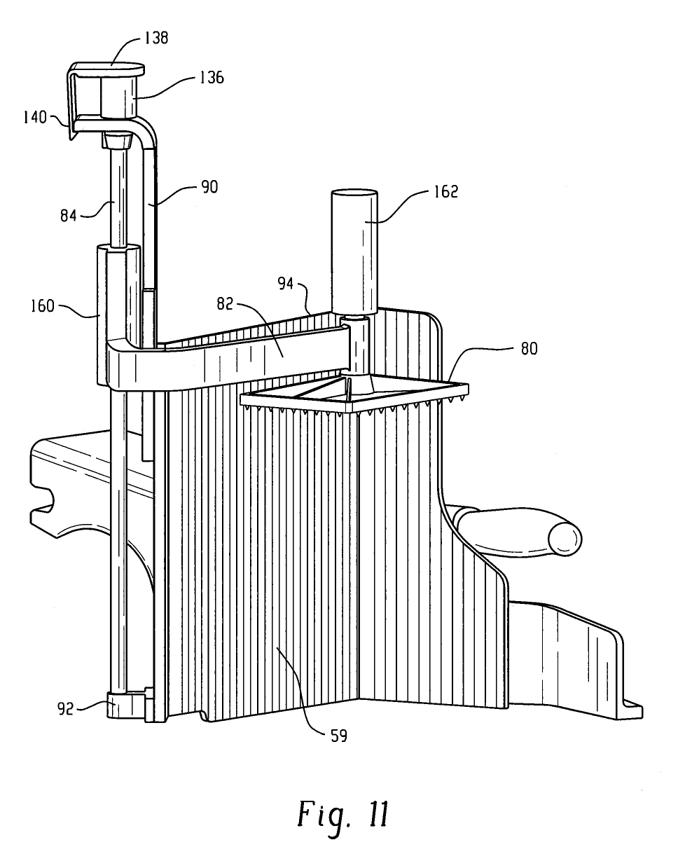

Referring to FIGS. 7-11, in another embodiment the bracket 90 includes an opening 130 that is includes a keyway 132 and the handle base includes a corresponding keyway feature 134. The keyway feature 134 prevents rotation of the slide rod and assures that the handle 136 is properly aligned with the bracket 90 to utilize a flexible retention clip 138 that is formed as a unitary molded part of the handle. As shown, the retention clip 138 is generally in the form of an L-shaped member with a free end 140 of the hanging or free leg of the L-shaped member having a lip 142 that faces toward the bracket and engages the underside 144 of the bracket to hold the slide rod in place. To remove the slide rod the free end 140 of the clip is pulled away from the bracket (e.g., in the direction of arrow 146) so that the lip 142 clears the bracket, enabling the slide rod to be pulled through the bracket opening 130 (e.g., in the direction of arrow 148). To reinstall the slide rod it is moved opposite to direction 148 through the opening 130, the keyway feature 134 is aligned with the keyway and as the slide rod continues to move an angled surface portion 150 of the lip will cause the free end 140 of the clip 138 to flex away from the bracket until the lip 142 passes the lower surface 144 of the bracket and moves back to an engaged or locking position. The clip end 140 is thus biased in the direction opposite the arrow 148.

In the embodiment of FIGS. 7-11 the lower bracket 92 includes an unthreaded opening that freely receives the opposite end of the slide rod 84, which may include a tapered surface 145 to facilitate insertion. A stope surface 147 may be provided on the handle base to assure that the lip 142 remains in contact with the bracket surface 144. As seen in FIG. 11, an end portion of the arm 82 of the food product pusher 80 defines a cylindrical mount 160 with a through opening that permits sliding along the rod 84 and rotating about the rod 84. A handle 162 is provided on the pusher to facilitate operator manipulation of the pusher.

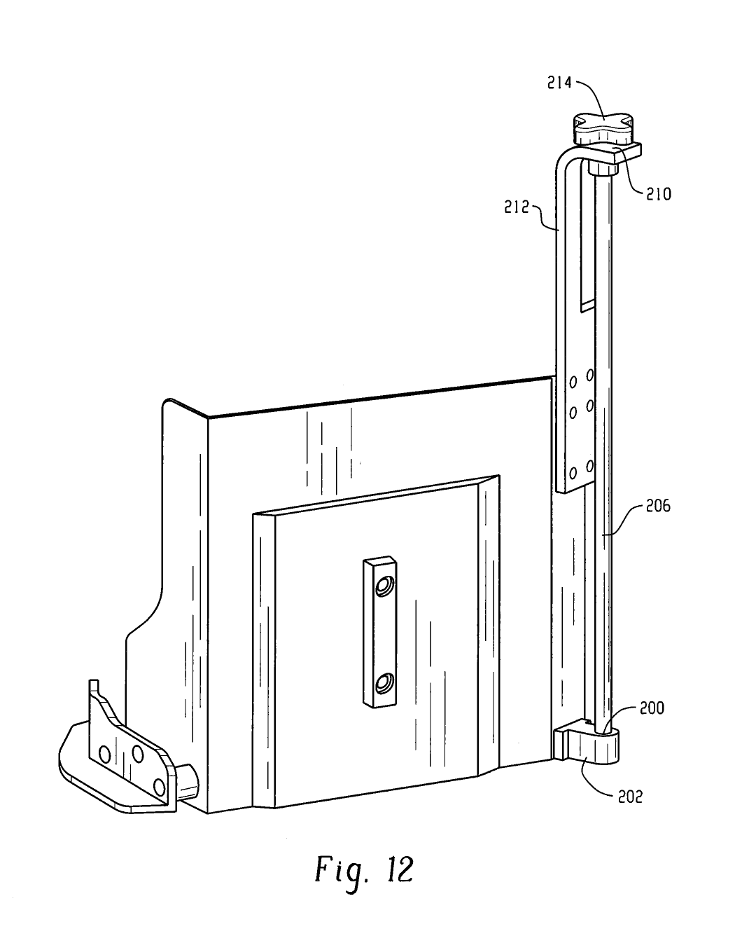

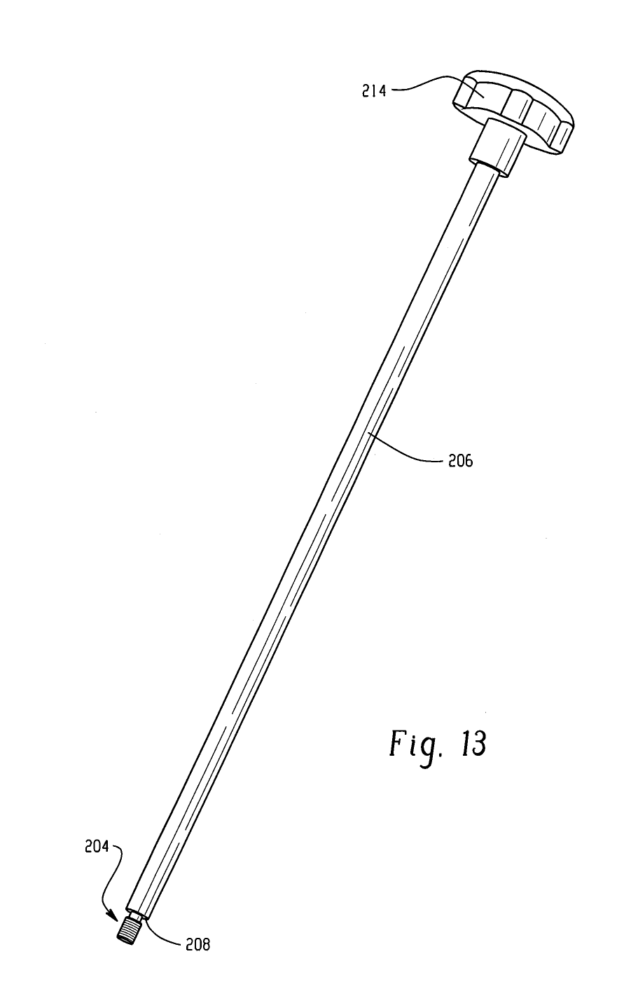

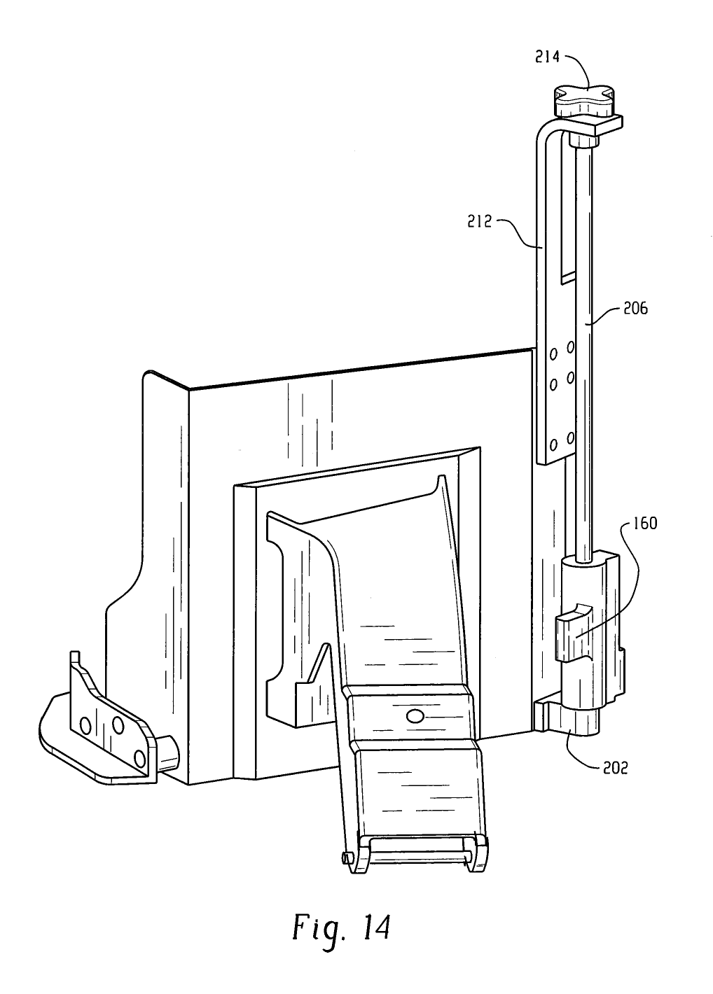

Referring to FIGS. 12-14, in another embodiment the opening 200 in the bracket 202 is threaded and configured to receive a threaded lower end 204 of the slide rod 206. The slide rod 206 also includes a step portion 208, located above the threaded lower end 204, which step portion is larger than the opening 200 and configured to stop the slide rod 206 from entering the opening 200 further once the step 208 comes into contact with the bracket 202. To install the slide rod 206, the threaded lower end 204 is inserted into and moves freely through the opening 210 located in bracket 212. The user, grasping the handle portion 214 of the slide rod 206, pushes the shaft of slide rod 206 through the opening 210 until the threaded lower end 204 comes into contact with the opening 200. Then the user inserts the threaded lower end 204 into the threaded opening 200 by rotating the handle portion 214 in a clockwise or tightening direction. The user continues to rotate the handle portion 214 until the step portion 208 comes into contact with the bracket 202. As shown, the base portion of the handle 214 also extends through the opening 210 in the bracket 212. To uninstall the slide rod, the process is reversed. The user rotates the handle portion 214 in a counter-clockwise or loosening direction until the threaded lower end 204 is clear of the threaded opening 200. Then the user pulls on the handle portion 214 and removes the slide rod 206 out through the unthreaded opening 210. In one embodiment, the handle portion 214 is of a plastic material that is overmolded onto the end of the metal shaft of the slide rod.

In a variation of the threaded type arrangement, opening 210 could threaded and configured to interface with a threaded surface of the base portion of the handle 214. To install the slide rod, the end opposite of the handle portion is insert into and moves freely through the threaded opening 210 until the threaded handle base comes into contact with the threaded opening 210. The user then rotates the handle portion 214 in a clockwise or tightening direction until the underside of the handle portion 214 comes into contact with the bracket 212. In this embodiment, the lower bracket 202 would simply include an unthreaded opening that freely or slidingly receives the end of the slide rod 206 opposite of the handle portion 214.

It is to be clearly understood that the above description is intended by way of illustration and example only and is not intended to be taken by way of limitation. Other changes and modifications could be made.

What is claimed is:

1. A food product slicer, comprising:
a base;
a knife mounted for rotation relative to the base;
a carriage mounted to the base for reciprocal movement back and forth past a cutting edge of the knife, the carriage including a food product tray, a slide rod and a product pusher mounted to the slide rod, wherein the slide rod is retained on the carriage with a biased member to enable the slide rod to be removed without the use of tools.

2. The slicer of claim 1 wherein the biased member is flexible clip member associated with the slide rod.

3. The slicer of claim 2 wherein the flexible clip member is a unitary part of a handle located at one end of the slide rod.

4. The slicer of claim 2 wherein the flexible clip member includes a free end with a lip that engages a slide rod mount bracket that is connected to the tray.

5. The slicer of claim 4 wherein the lip includes a tapered surface that interacts with the bracket during installation of the slide rod to cause the free end to flex to clear the bracket.

6. The slicer of claim 2 wherein a keyway arrangement is provided between a mount bracket and the slide rod to assure alignment of the flexible clip member with an edge portion of the mount bracket.

7. The slicer of claim 6 wherein a stop surface is located on the slide rod to limit passage of the slide rod through the mount bracket.

8. The slicer of claim 1 wherein the slide rod includes a handle end and an opposite end, and the biased member is a spring biased pin that is positioned to engage the opposite end of the slide rod.

9. The slicer of claim 1 wherein the slide rod includes a handle end and an opposite end, and the biased member is a spring biased pin that is positioned to engage the handle end of the slide rod.

10. A food product slicer, comprising:
a base;
a knife mounted for rotation relative to the base;
a carriage mounted to the base for reciprocal movement back and forth past a cutting edge of the knife, the carriage including a food product tray, a slide rod and a product pusher mounted to the slide rod, wherein the slide rod is removably retained to the carriage via a moveable biased member.

11. The slicer of claim 10 wherein the moveable biased member comprises a flexible member associated with the slide rod.

12. The slicer of claim 11 wherein the flexible member is a unitary part of a handle located at one end of the slide rod.

13. The slicer of claim 11 wherein the flexible member includes a free end with a lip that engages a mount bracket that is associated with the tray.

14. The slicer of claim 13 wherein the lip includes a tapered surface that interacts with the mount bracket during installation of the slide rod to cause the free end to flex to clear the bracket.

15. The slicer of claim 11 wherein a keyway arrangement is provided between a mount bracket and the slide rod to assure alignment of the flexible member with an edge portion of the mount bracket.

16. The slicer of claim 1 wherein the biased member is a spring biased pin member that engages a portion of the slide rod.

17. The slicer of claim 16 wherein a stop surface is located along the slide rod to position the spring-biased pin member in alignment with a groove or hole in the slide rod.

18. A food product slicer, comprising:
a base;
a knife mounted for rotation relative to the base;
a carriage mounted to the base for reciprocal movement back and forth past a cutting edge of the knife, the carriage including a food product tray, a slide rod including a threaded portion, and a product pusher mounted to the slide rod, wherein the slide rod is retained by securing the threaded portion into a threaded opening to enable the slide rod to be removed without the use of tools.

19. The slicer of claim 18, wherein the slide rod includes a handle end and an opposite end, the threaded portion is positioned at the opposite end, a first bracket is mounted to the tray and includes a threaded opening that receives the opposite end and a second bracket is mounted to the tray and includes an unthreaded opening that receives and holds the handle end.

20. The slicer of claim 19, wherein a handle located at the handle end of the slide rod is overmolded onto a metal shaft of the slide rod.
